(19) United States
(12) Patent Application Publication
(10) Pub. No.: US 2026/0040026 A1
(43) Pub. Date: Feb. 5, 2026

(54) GUIDED ANCHOR-FREE METHOD FOR ACCESS POINT LOCATION DETERMINATION

(71) Applicant: Cisco Technology, Inc., San Jose, CA (US)

(72) Inventors: Navid Reyhanian, Fremont, CA (US); Ardalan Alizadeh, Milpitas, CA (US); Liu Huang, Pleasanton, CA (US); Peiman Amini, Fremont, CA (US)

(21) Appl. No.: 18/789,826

(22) Filed: Jul. 31, 2024

Related U.S. Application Data
(60) Provisional application No. 63/615,409, filed on Dec. 28, 2023.

(51) Int. Cl. H04W 4/029; G01S 19/42

(52) U.S. Cl. CPC H04W 4/029; G01S 19/42

(57) ABSTRACT

A method to align a constellation of access points of a wireless local area network to, e.g., a floorplan, includes generating a representation of a constellation of access points of a wireless local area network area using inter-access point range finding, wherein data from the inter-access range finding is filtered based on a quality indicator associated with respective links between the access points, matching the representation of the constellation of access points to features of a map of a predetermined space, and identifying a location for each access point in the representation of the constellation of access points based on location information associated with the map.

### PRIORITY CLAIM

This application claims priority to U.S. Provisional Application No. 63/615,409, filed Dec. 28, 2023, the entirety of which is incorporated herein by reference.

### TECHNICAL FIELD

The present disclosure relates to wireless local area network (WLAN) operations, and more particularly to methods for identifying, with no, or limited, Global Navigation Satellite System (GNSS)/Global Positioning System (GPS) reception, the locations of Access Points (APs) of the WLAN within a building or other structure.

### BACKGROUND

The deployment of multiple wireless Access Points (APs) of a WLAN in a large facility is a complex undertaking. The deployment involves balancing numerous factors to determine the best location for each of a large number of APs. Further, the planned placement of the APs may be modified as new conditions are discovered or as changes occur within the facility.

Once the APs are installed, later determining the precise location of each AP for servicing or replacement can be challenging. The APs may be hidden behind walls, in ceilings, and in still other structures. Without an accurate map of the full constellation of APs, it may be difficult to locate any given AP for repair/replacement, or to optimally deploy new APs, for additional or improved network coverage.

### BRIEF DESCRIPTION OF THE DRAWINGS

FIG. 1 shows a portion of a WLAN in which AP constellation mapping techniques are employed, according to an example embodiment.

FIG. 2 shows an AP ground truth graph compared to an AP resolved constellation before rotation and transformation, according to an example embodiment.

FIG. 3 shows the AP ground truth graph of FIG. 2 compared to an AP resolved constellation after rotation and transformation, according to an example embodiment.

FIG. 4 shows the use of a single anchor AP in connection with a rotation and transformation process, according to an example embodiment.

FIG. 5 shows the use of three anchor APs in connection with a rotation and transformation process, according to an example embodiment.

FIG. 6 shows an AP ground truth graph compared to an AP resolved constellation rotated based on ellipses for anchors, according to an example embodiment.

FIG. 7 is a flowchart depicting an AP constellation mapping process, according to an example embodiment.

FIG. 8 is another flowchart depicting steps that may be executed by an AP constellation mapping process, according to an example embodiment.

FIG. 9 is a block diagram of a computing device that may be configured to perform an AP constellation mapping process, and to perform techniques described herein, according to an example embodiment.

### DETAILED DESCRIPTION

### Overview

A method to align a constellation of access points of a wireless local area network to, for example, a floorplan, is provided. The method includes generating a representation of a constellation of access points of a wireless local area network area using inter-access point range finding, wherein data from the inter-access point range finding is filtered based on a quality indicator associated with respective links between the access points. The method further includes matching the representation of the constellation of access points to features of a map of a predetermined space, and identifying a location for each access point in the representation of the constellation of access points based on location information associated with the map.

### Example Embodiments

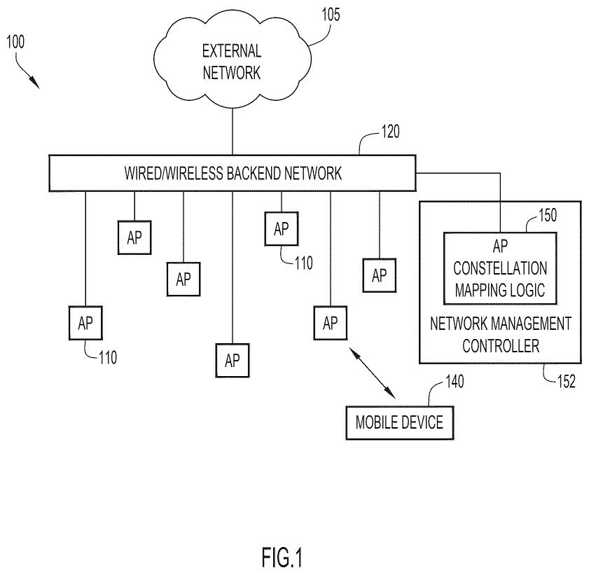

FIG. 1 shows a portion of a WLAN 100 including in which AP constellation mapping techniques are employed. The AP constellation mapping techniques may be performed by a computing device, such as a network management controller 152, executing AP constellation mapping logic 150, according to an example embodiment. More specifically, WLAN 100 includes multiple APs 110 connected to a wired (or wireless) backend network 120 that is configured to communicate with each AP 110 and an external network 105, e.g., the Internet. A mobile device 140 connects wirelessly through a given AP 110, enabling the mobile device to obtain network (e.g., Internet) services via the wired (or wireless) backend network 120. APs 110 may be deployed throughout a building, or on a given floor of a building, to provide wireless coverage to each mobile device 140.

In order to maintain reliable operation of WLAN 100, any given AP 110 may need to be replaced, and/or a given AP 110 may need to be added or moved to optimize the coverage of WLAN 100. Unfortunately, as noted, the APs 110 may not be visible (e.g., they could be behind walls or other structures), and thus it may be difficult for an operator of WLAN 100 to know where each of the APs 110 is located and/or where a new AP 110 should be deployed with respect to other APs 110. That is, a proper/accurate map of the AP constellation(s) (the respective locations of the AP 110) may not be available thus making it difficult to manage WLAN 100. The embodiments described herein provide an approach to automatically generate an AP constellation (i.e., data indicative of the latitude/longitude location of respective APs 110), and thus provide a visual tool for an operator of WLAN 100 to use to help manage the locations of APs 110 in WLAN 100. That is, the techniques described herein enable an administrator of WLAN 100 to better manage, and maintain, the operation of WLAN 100 by having the ability to automatically detect/determine the locations of, perhaps, hundreds of individual APs 110, especially when no accurate map of those locations is initially available. This enables the practical application of better and more precise management of the WLAN 110.

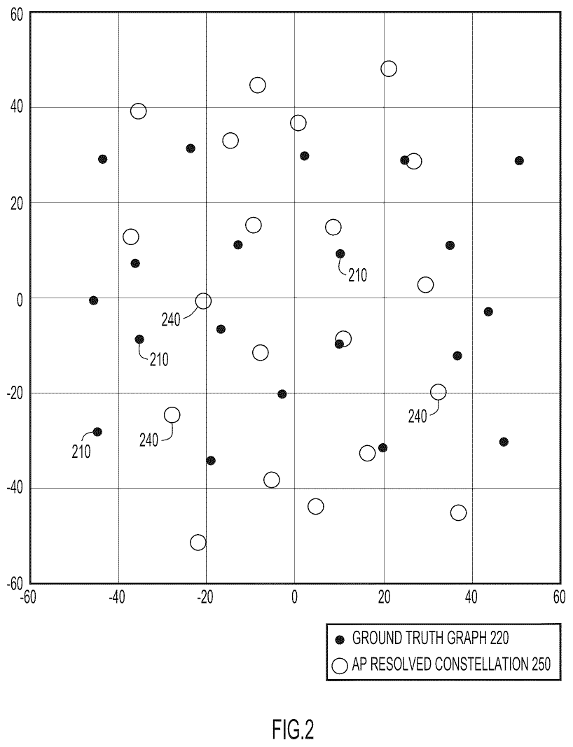

FIG. 2 shows a ground truth graph 220 comprising a mapping of accurate locations of APs 210 (some of which are labelled in the figure) compared to an AP resolved constellation 250 (indicated by the circles 240) before rotation and transformation, according to an example embodiment. That is, the ground truth graph 220 is a mapping of accurate locations of APs 210 to a given space (e.g., floorplan of a building) and the AP resolved constellation 250 is a mapping of relative locations of the APs 210, but not the actual locations (latitude/longitude) relative to a given space, e.g., relative to the floorplan of the building. The AP resolved constellation 250 may be generated, at the request of the network management controller 152 executing AP constellation mapping logic 150, using anchor-free methods, which may not employ any external infrastructure/anchor/beacons to provide positioning information. Instead, the presented methods may rely exclusively on measured distances between respective APs 210 to determine each unknown location.

For example, the ranging data measured by Wi-Fi®-based RTT (Round Trip Time) (i.e., IEEE 802.11mc/az, FTM (Fine Time Measurement)) may be used to generate the AP resolved constellation 250 and may be more reliable than geolocations extracted from GNSS/GPS in indoor environments. Accordingly, the AP resolved constellation 250 can be obtained accurately through anchor-free methods. That said, although the resulting AP resolved constellation 250 may be relatively accurate, it may still need rotations, transformations, and reflections to map it to the actual network shape (i.e., relative to a building floorplan). FIG. 2 shows AP resolved constellation 250 before such rotations, transformations, and reflections.

In accordance with embodiments described herein, AP constellation mapping logic 150 may be configured to automatically determine the geolocation of APs 110 in a given map (e.g., floorplan) by first employing anchor-free methods to find the AP resolved constellation 250. Then, AP constellation mapping logic 150 may be configured to fit the AP resolved constellation 250 into an “actual” shape of the map using a network floor map or floorplan. To carry out rotations, transformations, and reflections, different features such as the unsymmetric shape of the building can be used.

Once AP resolved constellation 250 is aligned with a building map (or floorplan), the AP resolved constellation 250 can be used to modify/update positions for “sloppy” anchors. In an embodiment, AP constellation mapping logic 150 may be configured to map sloppy anchors to the closest APs 110 in the aligned constellation. Correct latitude-longitude pairs for all anchors can be extracted from the building map or floorplan. After the position of sloppy anchors is corrected, AP resolved constellation 250 may run an anchor-based method, which may be more robust against non-line-of-sight links to enhance the location accuracy of selected APs 210.

Discussed next is how AP constellation mapping logic 150 may be configured to operate under several different scenarios.

1—Scenarios with No Informative Anchors

In this scenario, there is no anchor to “tie up” (or align) the network graph (i.e., the AP resolved constellation 250 to the floorplan). Examples of these scenarios are when anchors are less than three and when anchors are positioned collinearly. As noted, a challenge with an obtained graph (AP resolved constellation 250) from an anchor-free approach is that it typically needs rotations, transformations, and reflections. These operations can be performed efficiently by AP constellation mapping logic 150 when a detailed map (e.g., floorplan) is available. To carry out rotations, transformations, and reflections, AP constellation mapping logic 150 may be configured to consider different features such as the asymmetric shape of the building. For example, AP constellation mapping logic 150 may be configured to perform a rigid alignment, where transformation matrices are calculated based on the positions of anchors in the output of the anchor-free method and their actual positions. Once AP resolved constellation 250 is aligned with the building map (floorplan), the revised graph can be used to calculate the positions of all APs 110. In this regard, an appropriate map (floorplan) may be well-embedded with latitude and longitude numbers. Therefore, after alignment is complete, AP constellation mapping logic 150 is configured to obtain the latitudes and longitudes for all APs 110, which will, e.g., align with ground truth graph 220.

As examples of asymmetric shapes, the floor plan may be rectangular, not square. Such a feature may be used to adjust the AP resolved constellation 250 horizontally (i.e., if there are more APs along one axis compared to another axis). Further, the floor plan might indicate a stairwell (or other feature) where it might be unlikely to deploy an AP 110. As such, a line of several APs 110 in the AP resolved constellation 250 would likely not align with the stairwell (or other feature), suggesting the AP resolved constellation 250 should be moved or rotated.

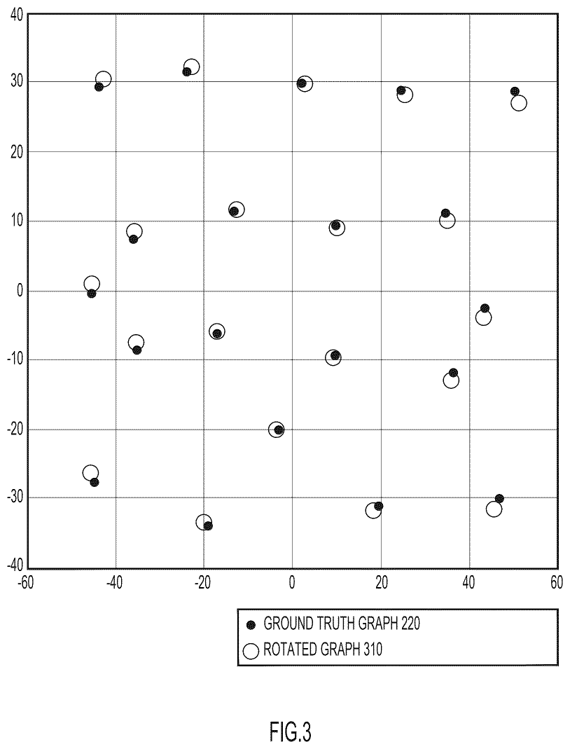

FIG. 3 shows the ground truth graph 220 of FIG. 2 compared to AP resolved constellation 250 after rotation and transformation thereof, according to an example embodiment. That is, using, for example, an appropriate floor plan, AP constellation mapping logic 150 aligns the AP resolved constellation 250 to rotated graph 310, which is closely aligned with, or tied to, the ground truth graph 220.

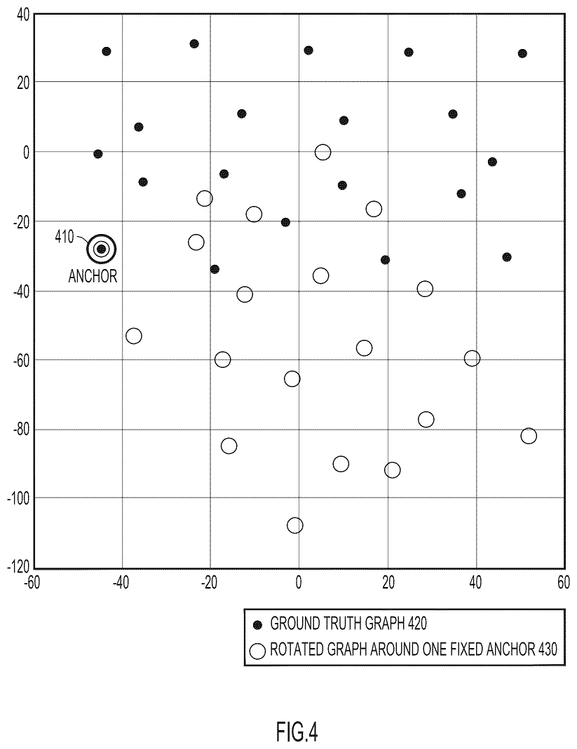

If no determinative detailed map feature is available, AP constellation mapping logic 150 can use manual anchors (i.e., where an administrator manually indicates/inputs a location of an AP) or GPS-assisted anchors (where GPS is used to automatically identify a location of an AP) to tie up the graph. For example, as shown in FIG. 4, one anchor 410 may be known and thus that AP may be considered fixed and the AP resolved constellation 250 can be rotated around anchor 410 to obtain an aligned graph 430 with ground truth graph 420.

2—Scenarios with Insufficient Anchors

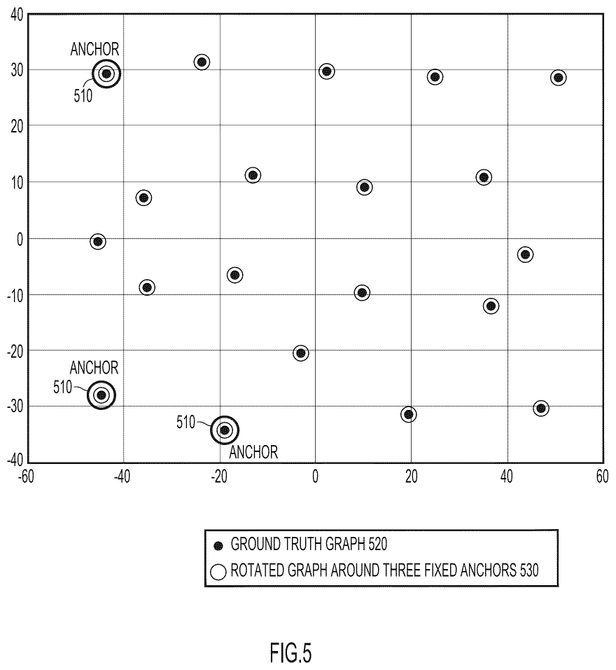

In these scenarios, the localization problem cannot be solved through anchor-based methods. Examples of these scenarios are when anchors are less than three and when anchors do not make a convex hull that includes all APs. In this case, AP constellation mapping logic 150 may be configured to use anchor-free methods to obtain the network graph. Depending on the number of (probably manually deployed) anchor APs and their position in the network, AP constellation mapping logic 150 may be configured to tie up the whole network graph obtained from the anchor-free method. This adjustment can be done by a rigid alignment, where transformation matrices are calculated based on the positions of anchors in the output of the anchor-free method and their actual positions. The goal is achieved more easily if anchor positions are non-collinear. In FIG. 5, three (e.g., manual) non-collinear anchors 510 are used to “tie up” or align the network graph such that rotated graph 530 aligns with ground truth graph 520.

3—Scenarios with Sufficient Anchors

When the number of GNSS/GPS-based anchors is large enough, the localization problem can be solved through anchor-based methods. However, anchor-based methods may be sensitive to anchor positions and thus, in accordance with an embodiment, AP constellation mapping logic 150 may be configured to refine the position of anchors using anchor-free methods.

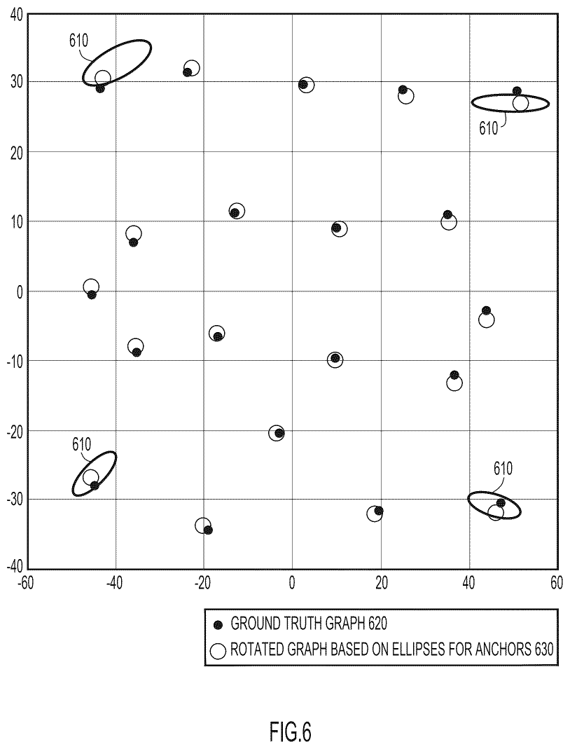

In some cases, GPS-assisted AP positions may be represented via ellipses (due to deficient or insufficient GNSS/GPS data) instead of deterministic nodes. Although finalizing one point in each ellipse could be difficult, the number of possible positions for GPS-assisted APs can be significantly reduced by tying up the entire network graph using ellipses for GPS-assisted nodes, as shown in FIG. 6.

More specifically, AP constellation mapping logic 150 may be configured to adjust the network graph to align with ground truth graph 620 such that the position of each estimated GPS-enabled AP is placed inside an ellipse 610 for that AP. In this way, AP constellation mapping logic 150 can simultaneously use all ellipses for GPS-enabled APs along with the network graph to significantly reduce the ellipse size for each GPS-enabled AP. This approach usually prevents GPS-enabled APs from being estimated to be located outside of the building, which is typically the case when positions for GPS-enabled APs are estimated on their own. As seen from FIG. 6, the graph 630 output from an anchor-free method can be rotated such that all anchors are placed inside their estimated ellipses 610 and one point is obtained for each anchor, such that a large ellipse is replaced by a final point.

### 4—Combined Scenarios

In practice, a combination of the above scenarios can take place. A combination of the above-proposed strategies can be deployed to adjust and tie up a network graph obtained from anchor-free methods. An example of the combined strategy is to use two known anchors and try to reflect and transform the solution such that it best matches the available floorplan.

### Other Considerations

### Link Filtering

In practice, ranging data that is used to generate the AP resolved constellation 250 can be erroneous due to environmental factors including, e.g., no line-of-sight links, or multi-path effects. Unfortunately, anchor-free methods are vulnerable to distance errors, especially when there are few links in the network. Several methods, described below, may be used to stabilize the anchor-free methods.

In accordance with an embodiment, AP constellation mapping logic 150 may use signal quality indicators such as Received Signal Strength Indicator (RSSI) values to pre-filter links that can potentially have large errors. Excluding links with large errors can guide anchor-free methods to provide more accurate solutions. In an embodiment, AP constellation mapping logic 150 may employ some or all of the following filtering steps.

Set a threshold value that indicates the least quality for links; and

Measured distances that have lower quality indicators compared to the threshold value are excluded when they are given to the anchor-free methods.

Once the output of an anchor-free method is obtained, distances among all APs are calculated and compared to measured distances, especially with those that have low signal quality indicators. If distances are close, then they are included in measurements that are fed to an anchor-free method. The final solution is obtained from an anchor-free method.

As noted, anchor-free methods are more sensitive to distance errors compared to anchor-based methods. AP constellation mapping logic 150 may be configured to guide and stabilize anchor-free methods using anchor-based methods. Processing steps may include the following.

Find manual anchors with the help of a detailed map or GNSS-enabled nodes that can make a convex hull.

Solve the anchor-based problem and find APs that lie inside the convex-hull of anchors. The APs that lie inside the convex-hull of anchors are considered accurate estimates, while APs out of the convex-hull of anchors are projected inside the convex-hull of anchors.

Calculate distances between APs that lie inside the convex-hull of anchors and use them instead of measured distances.

Run an anchor-free method with refined data.

Use APs that are located inside the convex hull of anchors to guide anchor-free methods to carry out transformation, reflections and rotations.

### Anchor Selection

In accordance with an embodiment, AP constellation mapping logic 150 may be configured to choose anchors from a set of APs. With proper selection of anchors from a set of APs, AP constellation mapping logic 150 can obtain reliable guidance to rotate, transform and reflect the AP resolved constellation 250 from anchor free methods.

When there are sufficient GNSS-enabled APs, the challenge is how to choose a subset of GNSS-enabled APs to guide the anchor-free method to carryout rotations, transformations and reflections. AP constellation mapping logic 150 may be configured to select a subset of APs based on the following preferences:
a) vertical and horizontal Dilution of Precision (DOP) are high;
b) a large number of satellites are observed within a 24-hour time window; and
c) the average SNR of received signals are above a predetermined threshold.

Once a subset of APs is chosen that satisfy the above criteria, AP constellation mapping logic 150 may be configured to verify whether APs can help the output of the anchor free method to carry out different ambiguity resolutions. In one embodiment, one rule is that anchors do not make a co-linear shape, i.e., a group of APs aligned along a single axis. As long as the subset of APs are not so aligned, they can be used to guide anchor-free outputs.

For floorplan-based and manual approaches, AP constellation mapping logic 150 may be configured to find at least three non-colinear APs and use those to align the output of anchor-free methods.

Once GNSS-enabled anchor APs are selected, based on the signal quality discussed above, a score may be assigned to each selected anchor. Once a score is assigned to each AP, probability density functions may be parameterized for an ellipse for each anchor. This parameterization specifies the probability density function of the feasibility region for each AP.

Once the probability density functions are parametrized by GNSS signal quality indicators, AP constellation mapping logic 150 may be configured to execute a semi-definite program to find the most probable positions of anchors.

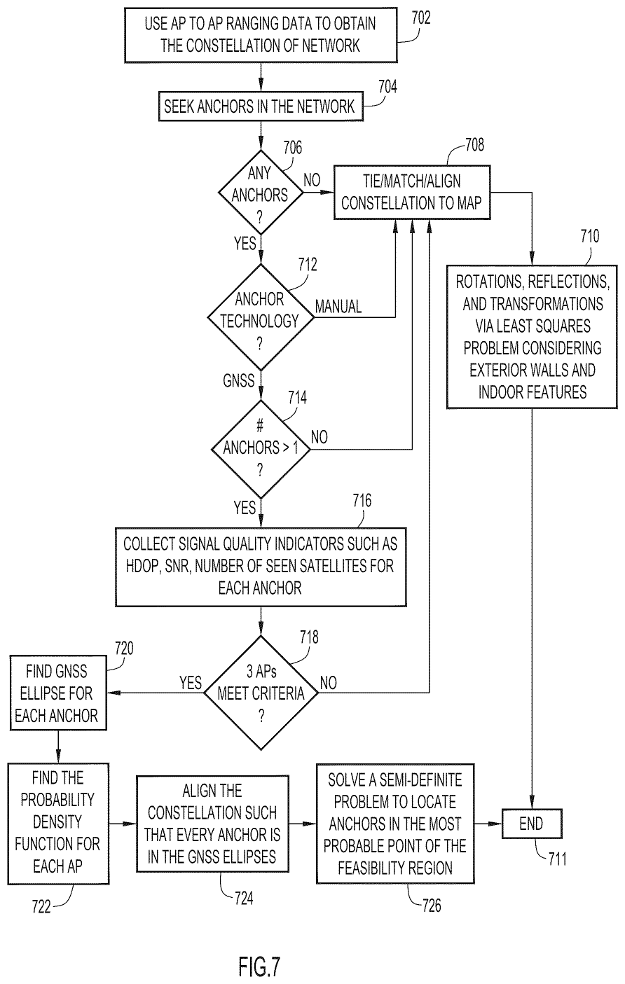

Several of the features, approaches, and processes discussed above are shown in FIG. 7, which is a flowchart depicting a series of steps that may be executed by AP constellation mapping logic 150, according to an example embodiment. At 702, AP to AP ranging is caused to be performed to obtain the constellation of the whole network (such as the AP resolved constellation 250). At 704, anchors are sought. At 706, it is determined whether any anchors are available. If no, then at 708, an operation attempts to tie the constellation to the map (using, e.g., building features). At 710, given the map (floorplan), appropriate rotations, reflections and transformations are performed via, e.g., least squares problem solving, considering, such as exterior walls and indoor features. The process would then end at 711.

If at 706, anchors were available, then at 712, it is determined what anchor technology is being used, i.e., manual or GNSS. If manual (e.g., inputting known coordinates of a given AP) then that information is provided to assist at operations 708, 710.

If the anchor technology is GNSS, then at 714 it is determined whether more than one such anchor is available. If not, the flow moves to 708.

If there are more than one anchor, then at 716, for each such anchor, signal quality indicators are collected including, for example, vertical/horizontal dilution of precision, signal to noise ratio (SNR), number of seen satellites. At 718, it is determined whether at least three APs meet predetermined criteria with respect to the collected signal quality indicators. If not, the process continues with operation 708 without the benefit of the anchors.

If at least three APs meet the predetermined criteria, then at 720, a GNSS ellipse is found for each anchor. Then, at 722, the probability density function for each AP is found. At 724, the constellation is then attempted to be aligned such that every anchor is in a respective GNSS ellipse. At 726, a semi-definite problem is solved to locate anchors in the most probable point of the feasibility region, and the process ends at 711.

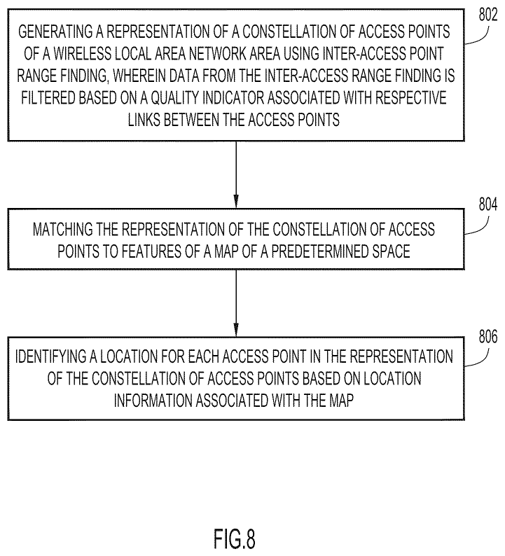

FIG. 8 is a flowchart depicting, at a higher level, a series of steps that may be executed by AP constellation mapping logic 150, according to an example embodiment. As shown, at 802, an operation includes generating a representation of a constellation of access points of a wireless local area network area using inter-access point range finding, wherein data from the inter-access range finding is filtered based on a quality indicator associated with respective links between the access points. At 804, an operation includes matching the representation of the constellation of access points to features of a map of a predetermined space. At 806, an operation includes identifying a location for each access point in the representation of the constellation of access points based on location information associated with the map.

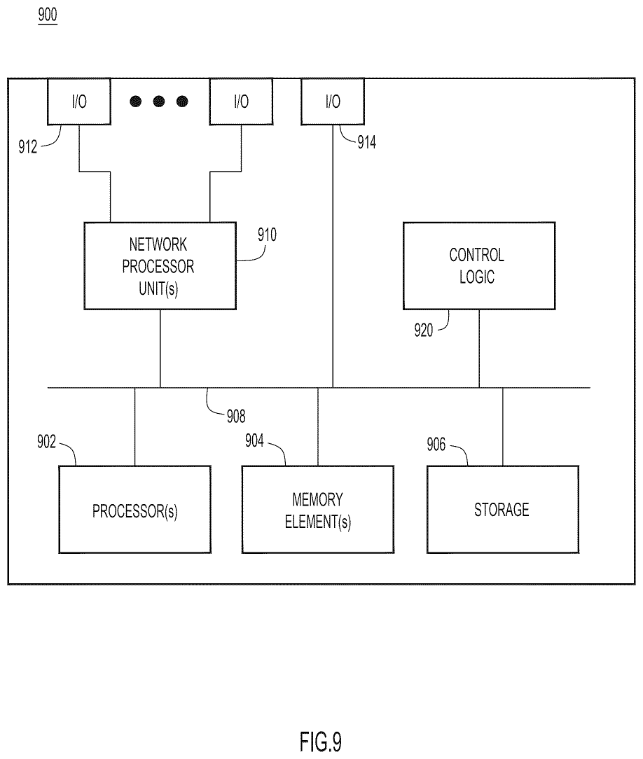

FIG. 9 is a block diagram of a computing device that may be configured to host AP constellation mapping logic, and to perform techniques described herein, according to an example embodiment. That is, FIG. 9 may be an implementation of network management controller 152. In various embodiments, a computing device, such as computing device 900 or any combination of computing devices 900, may be configured as any entity/entities as discussed for the techniques depicted in connection with FIGS. 1-8 in order to perform operations of the various techniques discussed herein.

In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920 (which could include AP constellation mapping logic 150). In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa) or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IOT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a computer-implemented method may include generating a representation of a constellation of access points of a wireless local area network area using inter-access point range finding, wherein data from the inter-access point range finding is filtered based on a quality indicator associated with respective links between the access points, matching the representation of the constellation of access points to features of a map of a predetermined space, and identifying a location for each access point in the representation of the constellation of access points based on location information associated with the map.

In the method, the quality indicator may include a received signal strength value.

In the method, the matching may be performed with an anchor-free procedure.

In the method, the matching may be performed with a combination of an anchor free procedure and an anchor-based procedure.

The method may further include designating at least one access point as an anchor access point.

The method may further include establishing a location of the anchor access point based on Global Navigation Global Navigation Satellite System (GNSS) or Global Positioning System (GPS) data.

The method may further include identifying the location of selected access points in the representation of the constellation of access points using a convex hull methodology.

The method may further include identifying the location of selected access point in the representation of the constellation of access points based on locations of ellipses obtained as a result of deficient Global Navigation Global Navigation Satellite System (GNSS) or Global Positioning System (GPS) data.

In the method, the inter-access point range finding comprises fine timing measurement.

The method may further include matching the representation of the constellation of access points to features of a map of a predetermined space based on an unsymmetrical shape of the predetermined space.

In another embodiment, a device may be provided and may include an interface configured to enable network communications, a memory, and one or more processors coupled to the interface and the memory, and configured to: generate a representation of a constellation of access points of a wireless local area network area using inter-access point range finding, wherein data from the inter-access point range finding is filtered based on a quality indicator associated with respective links between the access points, match the representation of the constellation of access points to features of a map of a predetermined space, and identify a location for each access point in the representation of the constellation of access points based on location information associated with the map.

In the device, the quality indicator may include a received signal strength value.

In the device, the one or more processors may be configured to match using an anchor-free procedure.

In the device, the one or more processors may be configured to match using a combination of an anchor free procedure and an anchor-based procedure.

In the device, the one or more processors may be configured to designate at least one access point as an anchor access point.

In the device, the one or more processors may be configured to establish a location of the anchor access point based on Global Navigation Global Navigation Satellite System (GNSS) or Global Positioning System (GPS) data.

In the device, the one or more processors may be configured to identify the location of selected access points in the representation of the constellation of access points using a convex hull methodology.

In yet another embodiment, one or more non-transitory computer readable storage media encoded with instructions are provided and that, when executed by a processor, cause the processor to: generate a representation of a constellation of access points of a wireless local area network area using inter-access point range finding, wherein data from the inter-access point range finding is filtered based on a quality indicator associated with respective links between the access points, match the representation of the constellation of access points to features of a map of a predetermined space, and identify a location for each access point in the representation of the constellation of access points based on location information associated with the map.

The one or more non-transitory computer readable storage media, wherein the quality indicator may include a received signal strength value.

The one or more non-transitory computer readable storage media, wherein the instructions may be configured to match using an anchor-free procedure.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
generating a representation of a constellation of access points of a wireless local area network area using inter-access point range finding, wherein data from the inter-access point range finding is filtered based on a quality indicator associated with respective links between the access points;
matching the representation of the constellation of access points to features of a map of a predetermined space; and
identifying a location for each access point in the representation of the constellation of access points based on location information associated with the map.

2. The method of claim 1, wherein the quality indicator comprises a received signal strength value.

3. The method of claim 1, wherein the matching is performed with an anchor-free procedure.

4. The method of claim 1, wherein the matching is performed with a combination of an anchor free procedure and an anchor-based procedure.

5. The method of claim 4, further comprising designating at least one access point as an anchor access point.

6. The method of claim 5, further comprising establishing a location of the anchor access point based on Global Navigation Global Navigation Satellite System (GNSS) or Global Positioning System (GPS) data.

7. The method of claim 4, further comprising identifying the location of selected access points in the representation of the constellation of access points using a convex hull methodology.

8. The method of claim 4, further comprising identifying the location of selected access point in the representation of the constellation of access points based on locations of ellipses obtained as a result of deficient Global Navigation Global Navigation Satellite System (GNSS) or Global Positioning System (GPS) data.

9. The method of claim 1, wherein the inter-access point range finding comprises fine timing measurement.

10. The method of claim 1, further comprising matching the representation of the constellation of access points to features of a map of a predetermined space based on an unsymmetrical shape of the predetermined space.

11. A device comprising:
an interface configured to enable network communications;
a memory; and
one or more processors coupled to the interface and the memory, and configured to:
generate a representation of a constellation of access points of a wireless local area network area using inter-access point range finding, wherein data from the inter-access point range finding is filtered based on a quality indicator associated with respective links between the access points;
match the representation of the constellation of access points to features of a map of a predetermined space; and
identify a location for each access point in the representation of the constellation of access points based on location information associated with the map.

12. The device of claim 11, wherein the quality indicator comprises a received signal strength value.

13. The device of claim 11, wherein the one or more processors are configured to match using an anchor-free procedure.

14. The device of claim 11, wherein the one or more processors are configured to match using a combination of an anchor free procedure and an anchor-based procedure.

15. The device of claim 14, wherein the one or more processors are configured to designate at least one access point as an anchor access point.

16. The device of claim 15, wherein the one or more processors are configured to establish a location of the anchor access point based on Global Navigation Global Navigation Satellite System (GNSS) or Global Positioning System (GPS) data.

17. The device of claim 14, wherein the one or more processors are configured to identify the location of selected access points in the representation of the constellation of access points using a convex hull methodology.

18. One or more non-transitory computer readable storage media encoded with instructions that, when executed by a processor, cause the processor to:
generate a representation of a constellation of access points of a wireless local area network area using inter-access point range finding, wherein data from the inter-access point range finding is filtered based on a quality indicator associated with respective links between the access points;
match the representation of the constellation of access points to features of a map of a predetermined space; and
identify a location for each access point in the representation of the constellation of access points based on location information associated with the map.

19. The one or more non-transitory computer readable storage media of claim 18, wherein the quality indicator comprises a received signal strength value.

20. The one or more non-transitory computer readable storage media of claim 18, wherein the instructions are configured to match using an anchor-free procedure.
